(19) United States
(12) Patent Application Publication
(10) Pub. No.: US 2010/0055404 A1
(43) Pub. Date: Mar. 4, 2010

(54) METHOD FOR PRODUCING FILM AND OPTICAL FILM

(75) Inventor: Akira YAMADA, Kanagawa (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/552,691

(22) Filed: Sep. 2, 2009

(30) Foreign Application Priority Data
Sep. 2, 2008 (JP) 2008-224705

(51) Int. Cl. B32B 3/00; B29C 47/00

(52) U.S. Cl. 428/156; 264/176.1

(57) ABSTRACT

A method for producing a film comprises the steps of melting a thermoplastic resin in an extruder having a hopper cooling zone, a feed zone, a compression zone, and a metering zone; discharging a melted resin from the extruder and supplying the same to a die; extruding the melted resin through the die in a sheet-like form; and cooling and solidifying the sheet-like melted resin to produce a film; wherein a relationship between a temperature, T₁ [° C.], of the melted resin in a first half of the feed zone and a temperature, T₂ [° C.], of the melted resin in a second half of the feed zone satisfies a following equation (1):

Tg+30≦T₂<T₁≦Tg+160 (1)
where a glass transition temperature of the resin is denoted by Tg.

### BACKGROUND OF THE INVENTION

1. Field of the Invention

The present invention relates to a method for producing a film and an optical film, especially to a film production method which can balance suppression of foreign matter generation and stable resin extrusion from an extruder, and to an optical film.

2. Description of the Related Art

A thermoplastic resin film is obtained by melting a thermoplastic resin in an extruder, discharging this melted resin through a die in a sheet-like form, cooling this sheet on a cooling drum, and peeling off the film. In this method, however, the resin charged into the extruder produces a large amount of gel because of a shear stress generated inside the extruder. These gel have been a cause of quality failure due to existence of residual foreign matter on the film.

Therefore, as a method to suppress generation of the gel, Japanese Patent Application Laid-Open No. 2003-311813 discloses a method to inhibit occurrence of the gel by lowering the shear velocity. Also, in Japanese Patent Application Laid-Open No. 2006-96001, it is disclosed that, by preheating the raw material resin to a predetermined temperature before it is charged into the extruder, the shear stress can be suppressed to a minimum, and as a result, generation of gel can be reduced.

In addition, it is described in Japanese Patent Application Laid-Open No. 2006-96001, that a lubricant may be added in order to decrease the shear stress. In order to suppress gel, it is also an effective method to inhibit oxidation by antioxidants.

Further, in recent years, with a flourishing liquid crystal display market, various films are being developed. For example, in Japanese Patent Application Laid-Open No. 2007-38646, there is described, as a method to produce an inclined phase difference film, a method whereby a melted resin is passed between two rolls having a different peripheral speed ratio.

### SUMMARY OF THE INVENTION

However, when extrusion of a resin is carried out using an additive, the friction between the resin and the barrel of an extruder, which serves as a drive force (feed force) to feed the resin, decreases because of the additive (the oil component of the additive makes the resin slip on the barrel). Thus, there has been a problem that the feed force is lowered and extrusion becomes unstable. In order to solve this problem, there has been employed a method whereby the temperature of the feed zone of an extruder is lowered in order to suppress melting of the additive and generate friction. However, when the temperature of the feed zone is low, gel is generated by the friction. Thus, there has been a demand for a method which can ensure a balance between decreased generation of foreign matter and stability in resin feeding.

The present invention has been made in consideration of these circumstances and its object is to provide a method for producing a film, which can ensure a balance between stable feeding of the melted resin material and suppression of foreign matter generation, and to provide an optical film.

In order to attain the object, the first aspect of the present invention provides a method for producing a film, comprising melting a thermoplastic resin in an extruder, discharging a melted resin from the extruder and supplying the same to a die, extruding the melted resin through the die in a sheet-like form, and cooling and solidifying the sheet-like melted resin to produce a film, wherein the extruder comprises, a feed zone, a compression zone, and a metering zone and at the same time, a relationship between a temperature, T₁ [° C.], of the melted resin in a first half of the feed zone and a temperature, T₂ [° C.], of the melted resin in a second half of the feed zone satisfies a following equation (1):

Tg+30≦T₂<T₁≦Tg+160 (1)

where glass transition temperature of the resin is denoted by Tg.

The inside of the extruder comprises, in order from the feed opening, a hopper cooling zone where the thermoplastic resin is taken from the feed opening, a feed zone where the thermoplastic resin is transported at a fixed rate, a compression zone where the thermoplastic resin is kneaded and compressed, and a metering zone where, while feeding the kneaded and compressed thermoplastic resin to the discharge opening, the discharged amount is measured.

According to the first aspect, first of all, the temperature of the first half of the feed zone is set higher in order to balance stable extrusion of the melted resin and suppression of gel generation. By doing so, the friction between the resin and the barrel can be decreased and, thus, generation of gel can be suppressed.

However, if the temperature of the feed zone is kept high, sufficient drive force (feed force) to feed the resin cannot be secured because of low friction and thus extrusion becomes unstable. Therefore, by making the temperature of the second half lower than the temperature of the first half of the feed zone, appropriate frictional force can be obtained and stable extrusion can be performed.

In addition, the temperature range of the melted resin in the feed zone is set (Tg+30)° C. or higher and (Tg+160)° C. or lower. With the temperature in this range, generation of foreign matter can be suppressed and a drive force to feed the resin can be generated in the second half of the feed zone.

The second aspect is characterized in that, in the first aspect, an additive to impart a slipping effect is added to the melted resin.

In the present invention, the feed force to feed the resin is secured by maintaining appropriate frictional force by lowering the temperature in the second half of the feed zone. Thus, even when an additive which imparts a slipping effect has been added to the melted resin, the feed force can be secured and the present invention can be carried out especially effectively.

The third aspect is characterized in that, in the first or second aspect, the relationship between the temperature, T₁ [° C.], of the melted resin in the first half of the feed zone and the temperature, T₂ [° C.], of the melted resin in the second half of the feed zone satisfies the following equation (2):

80>T₁−T₂>0 (2).

The third aspect defines the temperature of the first half of the feed zone and that of the second half of the feed zone, and the difference between the temperatures of the first half and the second half of the feed zone is preferably more than 0° C. and less than 80° C. With the difference in this range, the melted resin can be extruded stably. If the difference is 80° C. or higher, the friction becomes large, which sometimes causes occurrence of gel. If the difference is 0° C. or less, the feed force cannot be secured and thus the resin becomes difficult to be extruded stably.

The fourth aspect is characterized in that, in any one of the first to third aspects, a relationship between a temperature of the compression zone and a temperature of the metering zone satisfies the following equation (3):

metering zone temperature<compression zone temperature (3).

According to the fourth aspect, because the temperature of the metering zone is set lower than the temperature of the compression zone, thermal degradation of the resin is suppressed and generation of foreign matter and gel can be inhibited. Also, by setting the temperature of the compression zone higher, friction in the compression zone can be lowered and thus generation of gel can be suppressed.

The fifth aspect is characterized in that, in any one of the first to fourth aspects, a total length of the hopper cooling zone and the feed zone accounts for 30% to 60% of an effective length of a screw.

The fifth aspect defines the range of the feed zone inside the extruder. By setting the total length of the hopper cooling zone and the feed zone to 30% to 60% of the effective length of the screw, generation of gel can be suppressed.

The sixth aspect is characterized in that, in any one of the first to fifth aspects, temperature, T, of a raw material resin at an extruder inlet is in a range of (Tg−50)<T<Tg.

According to the sixth aspect, with the temperature of the thermoplastic resin at the extruder inlet in the aforementioned range, the viscosity of the thermoplastic resin can be made lower and thus generation of gel can be suppressed.

The seventh aspect is characterized in that, in any one of the first to sixth aspects, a discharge amount (Q/N) of the extruder is 30 to 80% of a theoretical maximum discharge amount (Q/N)_{MAX}.

According to the seventh aspect, by setting the discharge amount of the extruder to 30 to 80% of the theoretical maximum discharge amount, namely, by setting the resin filling rate inside the extruder in a range of 30 to 80%, friction inside the extruder can be suppressed and, therefore, generation of gel can be reduced.

The eighth aspect is characterized in that, in any one of the first to seventh aspects, a maximum shear stress, σ, generated inside the extruder, is 10<σ<500.

The eighth aspect defines the range of the maximum shear stress generated inside the extruder and generation of gel can be suppressed with the maximum shear stress within the above range.

The ninth aspect is characterized in that, in any one of the first to eighth aspects, an oxygen concentration inside the extruder is 100 ppm or less.

According to the ninth aspect, with the oxygen concentration inside the extruder in the above range, gel generated by oxidative crosslinking can be suppressed and thus it is possible to produce a film of high quality.

The tenth aspect is characterized in that, in any one of the first to ninth aspects, the thermoplastic resin is a cycloolefin resin.

The production method of the present invention can suppress generation of gel and foreign matter and can be carried out especially effectively when the thermoplastic resin is a cycloolefin resin.

The eleventh aspect is characterized in that, in any one of the first to tenth aspects, the discharged melted resin is nipped between two rolls having different peripheral speeds, and cooled and solidified to produce a film.

According to the eleventh aspect, retardation is generated in a thickness direction of a film by producing the film by nipping with two rolls having mutually different peripheral speeds. Therefore, if the feed amount of the resin is not stable, there arises a fluctuation in the film thickness to cause a difference in retardation in the thickness direction and to affect the optical characteristics, and it has not been possible to obtain a desired film. The present invention makes it possible to maintain the feed force for extrusion to feed the resin stably and thus can be used especially effectively in a film production method such as described above.

In order to attain the aforementioned object, the twelfth aspect of the present invention provides an optical film, which is obtained by a film production method according to any one of the first to eleventh aspects and characterized in that unevenness in film thickness in longitudinal and width directions is within ±0.25 μm.

The film obtained by the production method of the present invention has unevenness of ±0.25 μm in thickness in the longitudinal and width directions, and, thus, can be used suitably as an optical film.

According to the film production method of the present invention, generation of gel can be suppressed because the friction between the resin and barrel can be decreased by setting the temperature of the melted resin in the first half of the feed zone higher than the temperature of the melted resin in the second half of the feed zone inside the extruder. Thereafter, by lowering the temperature of the second half of the feed zone, appropriate frictional force can be obtained, securing the feed force to feed the resin, and, thus, the resin can be extruded stably. As described above, according to the present invention, suppression of gel generation and stable feeding of the resin can be balanced.

### BRIEF DESCRIPTION OF THE DRAWINGS

FIG. 1 is a schematic view showing a configuration of a film production apparatus used in a film production method of the present invention;

FIG. 2 is a schematic view showing a configuration of a screw extruder;

FIG. 3 is a schematic view showing a configuration of a film production apparatus of another embodiment used in a film production method of the present invention; and

FIG. 4A is a table showing test conditions and results of Examples;

FIG. 4B is a table showing test conditions and results of Examples;

FIG. 4C is a table showing test conditions and results of Examples;

### DETAILED DESCRIPTION OF THE PREFERRED EMBODIMENTS

Hereinafter, preferred embodiments of the method for producing a film according to the present invention will be described by referring to the accompanying stretchings.

### <<Film Production Method>>

### First Embodiment

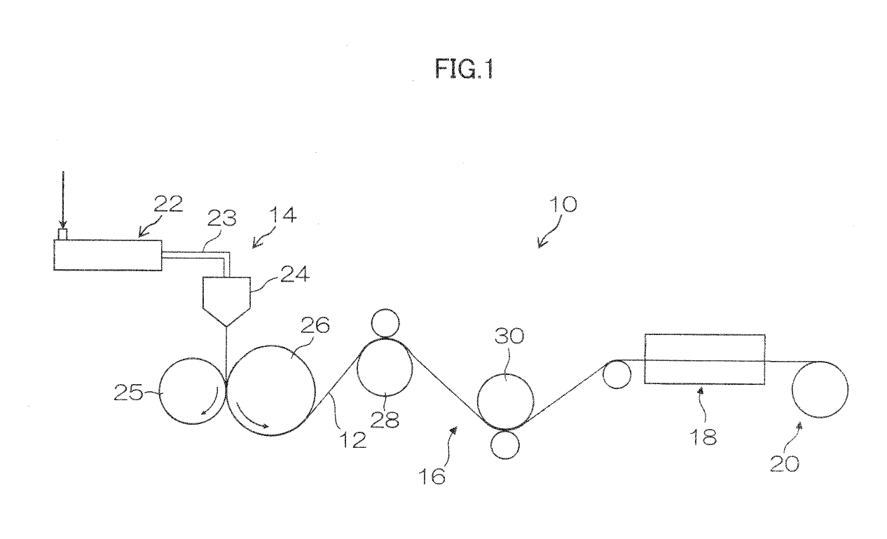

FIG. 1 shows a first embodiment of a skeleton framework of the film production apparatus. As is shown in FIG. 1, a film production apparatus 10 mainly comprises a film-forming process zone 14 where a resin film 12 before stretching is produced, a longitudinal stretching process zone 16 where the resin film produced in a film-forming process zone 14 is stretched longitudinally, a transverse stretching process zone 18 where the film is stretched transversely, and a take-up process zone 20 where the stretched resin film is taken up.

At the film-forming process zone 14, the thermoplastic resin melted by an extruder 22 is melt-extruded from a die 24 and the melt-extruded melted resin (hereinafter, may also be referred to as the “melt”) is continuously nipped between a first nipping face and a second nipping face, which constitute a nipping apparatus, to form the resin film 12. In FIG. 1, an example is illustrated where a touch roll 25 and a casting roll 26 are used, respectively, as the first and the second nipping face, which constitute the nipping apparatus. Also, in the present embodiment, it is preferable that the pressure placed on the melted material by the nipping apparatus is 20 to 500 MPa and the moving speed of the first nipping face is preferably set faster than the moving speed of the second nipping face. Application of such a large pressure, which has traditionally been thought to make the compression force larger and thus relatively lower the shear force, can generate retardation in the thickness direction. As a nipping apparatus where the speed is different between the first nipping face and the second nipping face, in addition to a combination of two rolls (the touch roll 25 and casting roll 26) having different peripheral speeds, shown in FIG. 1, there may be cited a combination of a roll and a touch belt having mutually different speeds and the like, which is described in Japanese Patent Application Laid-Open No. 2000-219752. Among these, one with two rolls having different peripheral speeds are preferable. The roll pressure can be measured by passing a pressure measuring film (manufactured by Fujifilm Corporation, a medium pressure “Prescale” and the like) between the two rolls.

This resin film 12 is, after being peeled off from the touch roll 25, is conveyed successively to the longitudinal stretching process zone 16 and the transverse stretching process zone 18 to be stretched, and is taken up in a roll form at the take-up process zone 20. Herewith, a stretched resin film 12 is produced. In the following, details of each process zone will be described.

### <Film-Forming Process Zone>

According to the method of the present invention, a composition comprising a thermoplastic resin (may sometimes be referred to as the “thermoplastic resin composition”) is first melt-extruded. Before the melt extrusion, it is preferable to pelletize the thermoplastic resin composition. There are cases where commercial thermoplastic resins (for example, TOPAS #6013, TARFLON MD1500, Delpet 980N, and DayLark D332) are already pelletized but, when they are not, there can be used the following method.

### (Pelletization)

Pellets can be prepared by drying the thermoplastic resin composition, melting the same at 150° C. to 300° C. by a biaxial kneader extruder, and extruding the melt in a noodle-like form, solidifying the noodle-like melt in air or in water, followed by cutting. Further, pelletization may be carried out by an underwater cutting method, whereby the resin composition, after being melted by an extruder, is directly extruded in water through a die and cut therein. The extruders used for pelletization include a uniaxial screw extruder, a non-intermeshing, counter-rotating biaxial screw extruder, an intermeshing, counter-rotating biaxial screw extruder, an intermeshing, co-rotating biaxial screw extruder, and the like. The rotational speed of the extruder is preferably 10 rpm to 1000 rpm, more preferably 20 rpm to 700 rpm. The extrusion residence time is 10 seconds to 10 minutes, more preferably 20 seconds to 5 minutes. The size of the pellet is not particularly limited but, generally, it is about 10 mm³ to 1,000 mm³, more preferably about 30 mm³ to 500 mm³.

Before melt-extrusion, it is preferable to decrease moisture contained in the pellets. The preferable drying temperature is 40 to 200° C., more preferably 60 to 150° C. Herewith, the moisture content is preferably decreased to 1.0% by mass or less, more preferably 0.1% by mass or less. Drying may be carried out in air, under nitrogen, or under vacuum.

### (Knead Melting)

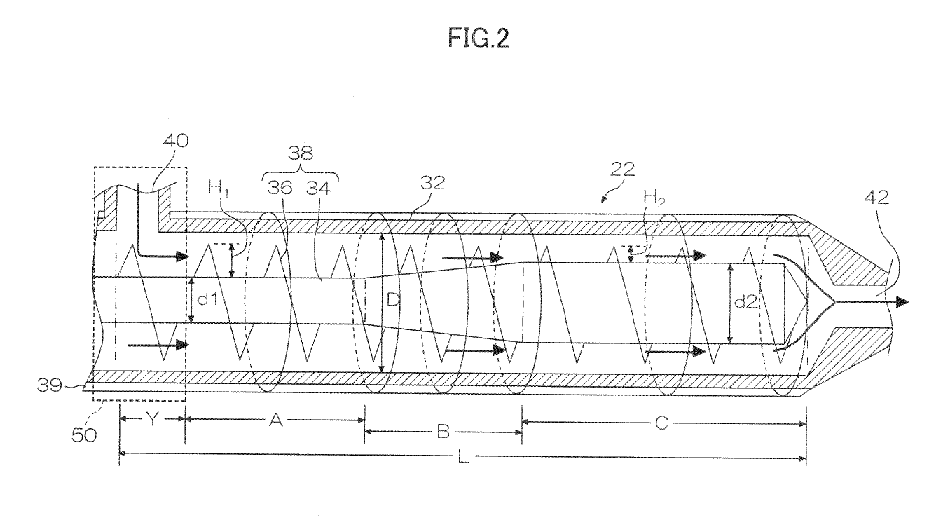

Next, the dried pellets are fed into the extruder through the feed opening, kneaded, and melted. In FIG. 2, a configuration of the extruder 22 is shown. As shown in the figure, the extruder 22 is an extruder of a uniaxial screw-type and has a uniaxial screw 38 installed in a cylinder 32. The uniaxial screw 38 comprises a screw blade 36 attached to the screw shaft 34, is supported in a freely rotatable manner, and is rotary driven by a motor which is not shown in the figure. In the following, the uniaxial screw extruder will be described referring to FIG. 2 but the same effect can be obtained even when a biaxial screw extruder is used.

On the periphery of the cylinder 32 is disposed a temperature regulating cylinder 39, which is divided into a plurality of sections, temperature of each section being designed to be regulated each independently, so that the temperature inside the cylinder 32 can be regulated at desired temperatures in steps.

The inside of the cylinder 32 comprises, in an order from the feed opening 40, a hopper cooling zone (the area shown by Y) where the thermoplastic resin is taken from the feed opening, a feed zone (the area shown by A) where a thermoplastic resin fed from the feed opening 40 is transported at a fixed rate, a compression zone (the area shown by B) where the thermoplastic resin composition is kneaded and compressed, and a metering zone (the area shown by C) where, while the kneaded and compressed thermoplastic resin is being fed to the discharge opening 42, the amount discharged is measured. Meanwhile, in the present invention, a resin inlet zone refers to the hopper cooling zone Y and a resin outlet zone refers to the metering zone C.

The total length of the hopper cooling zone and the feed zone of the extruder 22 is preferably 30% to 60% of the effective length of the screw, more preferably 40% to 50%. With the length in the above range, generation of gel can be suppressed. The screw compression ratio of the extruder is preferably 1.5 to 4.5. The ratio of the cylinder length to the inner diameter thereof is preferably 20 to 70 and the inner diameter of the cylinder is preferably 30 mm to 150 mm.

The extrusion temperature is determined depending on the melting temperature of the thermoplastic resin but, in the film production method according to the present invention, the temperature, T₁ [° C.], of the melted resin in the first half of the feed zone is set higher than the temperature, T₂ [° C.], of the melted resin in the second half of the feed zone. By setting the first half of the feed zone high, the friction force between the wall surface (barrel) of the cylinder 32 and the resin can be lowered and occurrence of the gel can be suppressed.

However, if the temperature of the whole of the melted resin in the feed zone is kept high at the temperature T, of the melted resin in a first half of the feed zone, the friction between the resin and the barrel, which serves as the drive force (feed force) to feed the resin, remains low and, thus, extrusion becomes unstable. Therefore, in the present invention, the temperature, T₂ [° C.], of the melted resin in the second half of the feed zone is set lower than the temperature, T₁ [° C.], of the melted resin in a first half of the feed zone to obtain suitable frictional force, which enables stable extrusion. Specific temperatures are: (Tg+30)≦T₂<T₁≦(Tg+160), more preferably (Tg+50)≦T₂<T₁≦(Tg+150), even more preferably (Tg+80)≦T₂<T₁≦(Tg+140). In addition, the temperature regulating cylinder 39 is usually partitioned into blocks and, in FIG. 2, each zone is partitioned into two blocks and separated into the first half and the second half. When the temperature regulating cylinder cannot be partitioned into two equal parts, the excess block is counted as the first half, making the first half longer. For example, when the temperature regulating cylinder is divided into three blocks, the first two blocks from the feed opening 40 form the first half of the feed zone and the remaining one block constitutes the second half of the feed zone. In addition, the temperature refers to the surface temperature or the set heating value of the temperature regulating cylinder.

Further, the difference between the temperature, T₁ [° C.], of the first half of the feed zone and the temperature, T₂ [° C.], of the second half of the feed zone is preferably more than 0° C. and less than 80° C., more preferably more than 20° C. and less than 70° C. With the temperature difference in this range, the melted resin can be extruded stably. If the temperature difference is 80° C. or more, the friction becomes too large and sometimes gel is generated. Further, if the temperature difference is 0° C. or less, sufficient feed force cannot be secured and stable extrusion becomes impossible.

In addition, it is preferable not to install a heating device in a zone which is located near feed opening of the extruder 22 (said zone is shown in FIG. 2 dotted line area 50) and includes the hopper cooling zone. Additionally, cooling device, for example which circulates cooling water around said zone may be installed in said zone. Accordingly heat transfer from temperature regulating cylinder 39 to the motor can be avoided and the motor can be protected from a trouble caused by heat.

In this manner, according to the film production method of the present invention, the feed force is secured at the second half of the feed zone, a portion where the temperature is lowered and, thus, stable extrusion is realized. At other portions, the temperature is maintained high in order to suppress generation of gel and foreign matter. Thus, the present invention is a production method which can balance stability in extrusion and suppression of gel.

Further, the temperature of the metering zone is preferably set at a temperature lower than the temperature of the compression zone. By setting the temperature of the metering zone low, thermal decomposition of the resin is inhibited and generation of foreign matter and gel can be suppressed. Specifically, the temperature of the metering zone is set preferably at (Tg+60)° C. or higher, more preferably (Tg+90)° C. or higher.

Furthermore, it is preferable to install a heating device (not shown in the figure) before the resin is charged into the extruder. By heating the resin before melting, the viscosity of the resin can be lowered rapidly and, therefore, the friction time in the course of plasticization can be shortened, and occurrence of gel due to crosslinking under shear and oxidative crosslinking can be suppressed. The temperature of the resin at the extruder inlet is preferably higher than (Tg−50)° C. and lower than Tg° C., more preferably higher than (Tg−30)° C. and lower than Tg° C., even more preferably higher than (Tg−10)° C. and lower than Tg° C. Further, the range of temperature fluctuation is preferably within ±5° C. Also, if, conversely, the temperature is too high, the resin sticks to the screw 38 in the feed zone A. The resin which stuck to the screw 38 in the feed zone A is fed to the compression zone B and is deteriorated by heat, which is not preferable.

The discharge amount (Q/N) of the extruder is set preferably within 30 to 80% of the theoretical maximum discharge amount, (Q/N)_{MAX}, more preferably within 50 to 80%, even more preferably within 60 to 70%. In addition, Q and N represent the discharge amount [cm³/min] and rotational speed [rpm] of the screw, respectively, and Q/N represents a discharge amount per one rotation of the screw. By setting the discharge amount (Q/N) in a range of 30 to 80% of the theoretical maximum discharge amount (Q/N)_{MAX}, namely, by keeping the resin filling rate inside the extruder in a range of 30 to 80%, friction inside the extruder can be lowered and, therefore, generation of gel can be suppressed.

Further, the maximum shear stress, σ, generated inside the extruder is preferably set in a range of 10<σ<500, more preferably 50<σ<300, even more preferably 100 <σ<200. With the maximum shear stress in the above range, generation of gel can be suppressed.

Furthermore, in order to prevent oxidation of the melted resin by residual oxygen, it is preferable to carry out extrusion under inert gas flow (nitrogen and the like) inside the extruder or under vacuum ventilation using an extruder equipped with a vent. The oxygen concentration inside the extruder 22 is preferably controlled at 100 ppm or less, more preferably 10 ppm or less.

### (Filtration)

In order to filter foreign matter contained in the thermoplastic resin composition, it is preferable to install a filtering apparatus having incorporated a breaker plate-type filer or a leaf-type disc filter. Filtration may be conducted in a single stage or multi stage filtration system. The filtering precision is preferably 15 μm to 3 μm, more preferably 10 μm to 3 μm. As a filter material, it is preferable to use stainless steel. As for a configuration of the filter material, there may be used a woven wire, or metal wire or metal powder which is sintered (sintered filer material). Above all, the sintered filter material is preferable.

### (Gear Pump)

In order to decrease a fluctuation in the discharge amount and to improve thickness precision, it is preferable to install a gear pump between the extruder and die. This will make it possible to control a fluctuation of the resin pressure inside the die within ±1%. To improve performance of quantitative feeding by the gear pump, there may also be used a method whereby the rotational speed of the screw is varied to regulate the pressure before the gear pump to a constant value.

### (Die)

The resin melted by the extruder, configured as described above, is continuously fed to the die via, if necessary, a filtering apparatus and a gear pump. The pipe 23 is a pipe to connect the discharge opening 42 of the extruder 22 and the die 24, and its outer peripheral surface is fully fitted with an aluminum casting heater or a heat media heater (not shown in the figure). This aluminum casting heater or heat media heater is regulated 180° C. or higher and 230° C. or lower, preferably 190° C. or higher and 230° C. or lower, more preferably 200° C. or higher and 225° C. or lower. Temperature regulation of the pipe 23 is preferably carried out by PI control or PID control. With the thus configured pipe 23, it is possible to control the fluctuation of the melted resin temperature within ±0.5° C. at the end of the pipe 23. With the fluctuation of the temperature within ±0.5° C., it is possible to stabilize viscosity of the melted resin.

The die may be of any type selected from a T die, fishtail die, and hanger coat die. Also, it is preferable to place a static mixer immediately before the die in order to improve uniformity of the resin temperature. The clearance of the T die outlet portion is generally suitable to be 1.0 to 30 times the film thickness, preferably 5.0 to 20 times.

It is preferable that the die has a clearance of 5 to 50 mm and can adjust a thickness of the film extruded through the die. Additionally, an automatic thickness controlling die, which calculates the film thickness and thickness deviation at downstream and feeds back the results to thickness control, is also effective. In addition to a monolayer film forming apparatus, it is possible to use a multilayer film forming apparatus to produce a multilayer film.

Herewith, the residence time after the resin is fed to the extruder through the feed opening until it comes out of the die is preferably 3 minutes to 40 minutes, more preferably 4 minutes to 30 minutes.

Next, the melt of the thermoplastic resin is extruded in a film-like form from the die 24, passed between two rolls, the touch roll (the first roll) 25 and casting roll (the second roll) 26, cooled and solidified to obtain a film. With regard to the surfaces of the touch roll 25 and casting roll 26, the arithmetic mean height (Ra) is usually 100 nm or less, preferably 50 nm or less, more preferably 25 nm or less.

In the production apparatus shown in FIG. 1, the film is produced by application of a roll pressure of 20 to 500 MPa, in addition to the conventional method whereby a film-like melt is passed between the two rolls. The roll pressure is preferably 20 to 300 MPa, more preferably 20 to 200 MPa, especially preferably 20 to 150 MPa. In a film production method as described above, where a high roll pressure is applied using a touch roll method, a distinct difference in optical characteristics is observed when the resin is not extruded stably or when gel and the like are present. Therefore, the film production method of the present invention can be used especially effectively in the film production method described above, because the present method enables stable extrusion of the resin and suppression of generation of foreign matter and gel.

In a conventional technique, a metal roll and an elastic roll of low hardness (for example, a rubber roll described in Japanese Patent Application Laid-Open No. 2003-25414, the surface of which is coated with metal) such as those described in, for example, Japanese Patent Application Laid-Open No. 2003-25414, have been used. Thus, when a large pressure of 20 MPa or more is applied, the rubber roll is deformed and the contact area with the melted resin increases, making it impossible to apply this kind of high pressure.

Therefore, in order to achieve this large roll pressure, it is preferable to use rolls which have Shore hardness of 45HS or greater. More preferable Shore hardness is 50 or greater, even more preferably 60 or greater.

The Shore hardness can be obtained as an average of the values measured at five points in the roll width direction and five points in the circumferential direction using a method described in JIS Z 2246.

In order to satisfy the above-mentioned Shore hardness, the material of the two rolls is preferably metal, more preferably stainless steel. Also preferable is a roll, the surface of which is treated with plating. On the other hand, it is preferable to avoid the use of a rubber roll and a metal roll lined with rubber, because the surfaces thereof have large concavities and convexities, and are liable to give scratches to the film surface.

As the touch roll, there can be used those described in, for example, Japanese Patent Application Laid-Open Nos. H11-314263, 2002-36332, H11-235747; WO 97/28950; Japanese Patent Application Laid-Open No. 2004-216717 and 2003-145609.

Further, by adjusting the peripheral speed ratio of the two rolls between which the film-like melt is passed, an optical film is produced with shear stress imparted to the melted resin when it passes between the two rolls. The peripheral speed ratio is preferably set at 0.60 to 0.99, more preferably 0.75 to 0.98. Here, the peripheral speed ratio of two rolls refers to a ratio, (peripheral speed of the slower roll)/(peripheral speed of the faster roll).

The larger the peripheral speed ratio of the two rolls, the larger becomes the absolute value of the difference between Re (40°) and Re (−40°) of the film obtained. On the other hand, however, when the difference in the peripheral speed is too large, the surface of the film obtained becomes easier to be scratched. In the present invention, with the peripheral speed ratio of the two rolls kept in the above-mentioned range, the surface of the film is hard to be scratched and a film having good smoothness can be produced stably.

In order to obtain a desired film, it does not matter whichever of the two rolls moves faster. However, when the touch roll 25 moves slower, a melted resin bank is formed on the side of the touch roll 25. Because the contact time of the touch roll 25 with the melted resin is short, the bank formed on the side of the touch roll cannot be cooled sufficiently. Then a surface roughness or uneven thickness and the like tend to be generated because a part of resin remains on the touch roll. As a result, it is liable to cause surface defects of a film. Therefore, it is preferable that the slower roll is the casting roll (the second roll) 26 and that the faster roll is the touch roll (the first roll) 25.

Further, it is preferable to use rolls with large diameters. Specifically, it is preferable to use two rolls with diameters of 350 to 600 mm, more preferably 350 to 500 mm. When rolls with large diameters are used, the contact area between the sheet-like melt and the rolls become larger, and the time the melt is under shear stress becomes longer. Thus, a film having a large difference between Re (−40°) and Re (−40°) can be produced with, in addition, its fluctuation being suppressed. By the way, the diameters of the two rolls may be the same or different.

The two rolls may be freely driven or independently driven but, in order for the fluctuation to be suppressed, they are preferably independently driven. As mentioned above, the two rolls are driven with different peripheral speed. Moreover, in order to make the difference between Re (40°) and Re (−40°) larger, the surface temperature of the two rolls may be set differently. The temperature difference is preferably 5° C. to 80° C., more preferably 20° C. to 80° C., even more preferably 20° C. to 60° C. In doing so, the temperature of the two rolls is, using the glass transition temperature of the resin, Tg, set preferably at (Tg−70)° C. to (Tg+20)° C., more preferably at (Tg−50)° C. to (Tg+10)° C., even more preferably (Tg−40)° C. to (Tg+5)° C. This kind of temperature regulation can be accomplished by passing a temperature-regulated liquid or gas inside the touch roll.

In addition, the glass transition temperature of the resin is determined by using a differential scanning calorimeter (DSC) in the following way: the sample is placed in a measurement pan and, under nitrogen, the temperature is elevated from 30° C. to 300° C. at a rate of 10° C./min (1st-run), thereafter cooled to 30° C. at a rate of −10° C./min, and again heated up from 30° C. to 300° C. at a rate of 10° C./min (2nd-run). In the 2nd-run, the temperature at which the baseline begins to inflect from the low temperature side is read as the glass transition temperature (Tg).

Furthermore, it is preferable to keep the melted resin warm after the resin is melt-extruded from the die until it comes in contact with at least one of the two rolls thereby to decrease a temperature distribution in the width direction. Specifically, it is preferable to keep the temperature distribution in the width direction within ±5° C. In order to decrease the temperature distribution, it is preferable to dispose a member having a heat insulating function or heat reflection function somewhere along a passage of the melt between the die and the two rolls, thus shielding the melt from the outside atmosphere. In this way, by disposing a heat insulating member along the passage and shielding the melt from the outside atmosphere, it becomes possible to suppress the effect of the outside environment, for example, wind, and can control the temperature distribution of a film in the width direction. The temperature distribution of the film-like melt in the width direction is preferably within ±3° C., more preferably ±1° C.

Further, by using the shielding member, the film-like melt can be passed between the rolls in a state where the temperature of the melt is high, namely in a state where the melt viscosity is low, and thus there is obtained another effect that the film can be produced more easily.

In addition, the temperature distribution of the film-like melt can be measured by a contact thermometer or non-contact thermometer.

The shielding plate is installed, for example, inside both ends of the two rolls and with a gap from the side of the die in the width direction. The shielding plate may be fixed directly to the side of the die or may be supported and fixed by a supporting member. The width of the shielding plate is equivalent to the width of the die or more, so that the shielding plate can effectively block the rising air current caused by heat dissipation from the die.

The gaps between the shielding plate and the ends of the film-like melted resin in the width direction are preferably formed narrow from a standpoint of effectively blocking the rising air current which flows in along the roll surfaces. The shield is more preferably installed at distances of about 50 mm from the width direction ends of the film-like melt. In addition, there is not necessarily a need to dispose gaps between the sides of the die and the shield, but it is preferable that the gaps are formed to such an extent that the air flow in the space framed by the shield can be ventilated, with the gap being, for example, 10 mm or less.

Further, as a material having a heat insulation function and/or heat reflection function, one with an excellent wind shielding property and heat retaining property is preferable. For example, metal plates such as stainless steel may preferably be used.

To further decrease the fluctuation of the difference between the retardation values, there is a method whereby adhesion between the film-like melted resin and the casting roll at the time of contact is improved. Specifically, adhesion can be improved by a combination of electrostatic application method, air knife method, air-chamber method, vacuum nozzle method, and the like. This kind of adhesion improvement method can be carried out on the whole or a portion of the surface of the film-like melted resin.

Further, even though not shown in the figure, it is desirable to cool the film, after it is produced as described above, using one or more casting rolls in addition to the two rolls (for example, a casting roll and touch roll) between which the film-like melt is passed. The touch roll is usually disposed in such a way that it touches the first casting roll of the most upstream side (nearest to the die). Generally, use of three cooling rolls is practiced relatively often but the number thereof is not limited to this. The interval between the surfaces of a plurality of casting rolls is preferably 0.3 mm to 300 mm, more preferably 1 mm to 100 mm, even more preferably 3 mm to 30 mm.

Further, it is preferable to trim away both ends of the processed film. The portion cut off by trimming may be crushed and used again as a raw material. Also, it is preferable to have one end or both ends of the film subjected to a thickening treatment (knurling treatment). The height of the concavity and convexity produced by the thickening treatment is preferably 1 μm to 50 μm, more preferably 3 μm to 20 μm. The thickening treatment can be carried out in such a way that convexity is formed on both surfaces or on one surface. The width of the thickening treatment is preferably 1 mm to 50 mm, more preferably 3 mm to 30 mm. The extrusion process can be carried out at room temperature to 300° C. Before take-up, it is also preferable to apply a laminate film on one surface or both surfaces. The thickness of the laminate film is preferably 5 μm to 100 μm, more preferably 10 μm to 50 μm. The material of the laminate film is not particularly limited and includes polyethylene, polyester, polypropylene, and the like.

The resin film produced in the film-forming process zone 14 may, before being subjected to longitudinal stretching and transverse stretching, be taken up in a roll shape and delivered to the subsequent process. The take-up tension is preferably 2 kg/m-width to 50 kg/m-width, more preferably 5 kg/m-width to 30 kg/m-width.

### [Stretching Process]

Furthermore, after the film is formed according to the method described above, the film may be subjected to stretching and/or a relaxation treatment. For example, each process may be conducted by the following combinations, (a) to (g):

(a) transverse stretching,
(b) transverse stretching→relaxation treatment,
(c) longitudinal stretching,
(d) longitudinal stretching→relaxation treatment,
(e) longitudinal (transverse) stretching→transverse (longitudinal) stretching,
(f) longitudinal (transverse) stretching→transverse (longitudinal) stretching→relaxation treatment, and
(g) transverse stretching→relaxation treatment→longitudinal stretching→relaxation treatment.

Especially preferable among these are the processes (a) to (d). In addition, FIG. 1 represents a production apparatus used for a production method comprising a transverse stretching process carried out after a longitudinal stretching process.

### <Longitudinal Stretching Process Zone>

The longitudinal stretching can be accomplished by heating the film between two pairs of rolls and making the peripheral speed of the rolls on the outlet side faster than that of the rolls on the inlet side. In doing so, by varying the length (L) between the pairs of rolls and the film width (W) before stretching, degree of development of retardation in the thickness direction can be changed. With L/W (referred to as a vertical-to-horizontal ratio) in a range of 2 to 50 or less (long-span stretching), a film with small Rth is easy to be produced, and with L/W in a range of 0.01 to 0.3 (short-span stretching), a film with large Rth can be produced. In the present embodiment, any of the long-span stretching, short-span stretching, or intermediate of these (intermediate stretching where L/W is more than 0.3 and 2 or less) may be used but the long-span stretching and short-span stretching, which can make the orientation angle small, are preferable. Further, it is more preferable to differentiate the use in the following way: short-span stretching for high Rth and long-span stretching for low Rth.

The temperature for stretching is preferably (Tg−10)° C. to (Tg+60)° C., more preferably (Tg−5)° C. to (Tg+45)° C., even more preferably (Tg−10)° C. to (Tg+20)° C. or lower. In addition, the preferable transverse stretching ratio is 1.2 to 3.0 times, more preferably 1.2 to 2.5 times, even more preferably 1.2 to 2.0 times.

### <Transverse Stretching Process Zone>

Transverse stretching can be carried out using a tenter. That is, stretching is conducted by holding both ends of the film in the width direction with clips and widening the film in a transverse direction. At this time, the stretching temperature can be regulated by sending a wind of desired temperature into the tenter. The stretching temperature is preferably (Tg−10)° C. to (Tg+60)° C., more preferably (Tg−5)° C. to (Tg+45)° C., even more preferably (Tg−10)° C. to (Tg+20)° C. or lower. In addition, the preferable transverse stretching ratio is 1.2 to 3.0 times, more preferably 1.2 to 2.5 times, even more preferably 1.2 to 2.0 times.

It is possible to make the distribution of Re and Rth after stretching smaller and decrease the fluctuation of an orientation angle accompanying bowing, by carrying out preheating before stretching and heat fixation after stretching. It may be sufficient if either preheating or heat fixation is carried out but it is more preferable that both are performed. These preheating and heat fixation are preferably carried out with the film gripped by clips, that is, these treatments are preferably carried out in series with stretching.

Preheating may be carried out at a temperature higher than the stretching temperature by about 1° C. to 50° C., preferably by 2° C. to 40° C. or less, more preferably by at least 3° C. and at most 30° C. The time of preheating is preferably at least 1 second and at most 10 minutes, more preferably at least 5 seconds and at most 4 minutes, even more preferably at least 10 seconds and at most 2 minutes. At the time of preheating, it is preferable to keep the width of the tenter nearly constant. Here, the term “nearly” refers to ±10% of the width of the unstretched film.

Heat fixation may be performed at a temperature lower than the stretching temperature by at least 1° C. and at most 50° C., preferably by at least 2° C. and at most 40° C., more preferably by at least 3° C. and at most 30° C. Even more preferably, the heat fixation temperature is set at the stretching temperature or lower and at Tg or lower. The heat fixation time is preferably at least 1 second and at most 10 minutes, more preferably at least 5 seconds and at most 4 minutes, even more preferably at least 10 seconds and at most 2 minutes. At the time of heat fixation, it is preferable to keep the width of the tenter nearly constant. Here, the term “nearly” refers to 0% (the same width as the tenter width after stretching) to −10% (the width is shrunk by 10% from the tenter width after stretching=width shrinkage). If widened than the stretched width, residual strain becomes easier to be generated in the film, which is not preferable.

### <Relaxation Treatment>

Further, dimensional stability of the film can be improved by carrying out a relaxation treatment after these stretching processes. Heat relaxation is preferably performed after any one or two of the film-forming, longitudinal stretching, and transverse stretching processes. The relaxation treatment may be carried out online in succession to stretching or offline after being taken up after stretching.

The heat relaxation is preferably carried out, while the film is being conveyed, at (Tg−30)° C. to (Tg+30)° C., more preferably at (Tg−30)° C. to (Tg+20)° C., even more preferably at (Tg−15)° C. to (Tg+10)° C.; for 1 second to 10 minutes, more preferably for 5 seconds to 4 minutes, even more preferably for 10 seconds to 2 minutes; and under a tensile force of 0.1 kg/m to 20 kg/m, more preferably 1 kg/m to 16 kg/m, even more preferably 2 kg/m to 12 kg/m.

### Second Embodiment

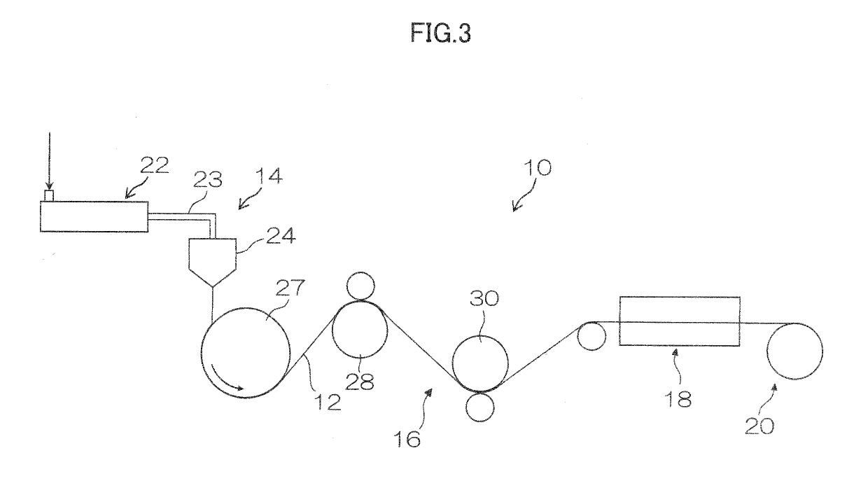

FIG. 3 shows a second embodiment of a skeleton framework of the film production apparatus. The film production apparatus shown in FIG. 3 is different from the production apparatus shown in FIG. 1 in that the roll which cools the sheet-like melted resin extruded from the die comprises a casting roll 27 only. With the film production apparatus in the second embodiment, the same effect as in the first embodiment can be obtained.

Further, though, in the first embodiment, the film is produced by rotating two rolls at different peripheral speeds and putting higher roll pressure than the conventional pressure, production of a film can also be carried out by setting the same peripheral speed for the rolls and setting the roll pressure of about 0.1 MPa to 5 MPa, which is a pressure of the same level as the conventional pressure.

### <<Film>>

The film produced by the above first embodiment of the film production method of the present invention comprises a thermoplastic resin and is characterized in that, in a plane containing a longitudinal direction and normal line of the film, a retardation value, Re[0°], measured from the normal line at a wavelength 550 nm, a retardation value, Re[+40°], measured from a direction tilted from the normal line by an angle +40°, and a retardation value, Re[−40°], measured from a direction tilted from the normal line by an angle −40°, concurrently satisfy the following relational expressions (I) and (II).

60 nm≦Re[0°]≦300 nm (I)

40 nm≦|Re[+40°]−Re[−40°]|≦300 nm (II)

In the present description, “a direction inclined from the normal line by an angle of 0°” is defined as a direction tilted from the normal line direction towards the film plane direction by an angle of 0°, with the longitudinal direction of the film as the direction of tilt. That is, the normal line of the film is a direction with a tilt angle of 0° and an arbitrary direction in the film plane is a direction with a tilt angle of 90°.

The value, |Re[+40°]−Re[−40°]| of the film is 60 to 250 nm, preferably 60 to 200 nm, more preferably 80 to 180 nm. Further, the in-plane retardation value, Re(0°), is 60 to 250 nm, more preferably Re(0°) is 60 to 200 nm, and even more preferably 80 to 180 nm. Furthermore, a retardation in the film thickness direction, Rth, is preferably 40 to 500 nm, more preferably 40 to 350 nm, even more preferably 40 to 300 nm.

When an optical film satisfying the aforementioned range is used for optical compensation of TN mode, ECB mode, and OCB mode liquid crystal displays, it contributes to improvement of viewing angle characteristics and makes it possible to achieve widening of the viewing angle.

An optical film produced by the production method of the present invention is not particularly limited as to its thickness but, when it is used for the liquid crystal displays and the like, the thickness is, from a viewpoint of thinning, preferably 100 μm or less, more preferably 80 μm or less, even more preferably 60 μm or less, particularly preferably 40 μm or less. The production method of the present invention makes it possible to produce such a thin film, which is one of the differences from the conventional techniques.

Fluctuations of the Re(0), Re(+40°), and Re(−40°) values, when the film is used in liquid crystal displays, result in display unevenness and, thus, the smaller the fluctuations are, the more preferable. Specifically, the fluctuations are preferably within ±3 nm or less, more preferably within ±1 nm or less. Further, a fluctuation in the angle of a retarded phase axis also becomes a cause of display unevenness and, thus, the smaller the fluctuation, the more preferable. Specifically, the fluctuation is preferably within ±1°, more preferably within ±0.5°, especially preferably within ±0.25°. In addition, the direction of the retarded phase axis of the film depends on the production method of the present film, the production method being described later. For example, when a resin having a positive inherent birefringence property is passed between two rolls, the retarded phase axis takes the same direction as the longitudinal direction of the film.

The aforementioned optical characteristic values can be measured by the following methods.

The Re(0), Re(+40°), and Re(−40°) values of the film are obtained, using KOBRA 21ADH or WR (manufactured by Oji Scientific Instruments Ltd.), by measuring a phase difference at a tilt angle of +40° and a phase difference at a tilt angle of −40° in a plane containing the longitudinal direction and normal line of the film, with the longitudinal direction as the direction of tilt. In addition, the wavelength of measurement is set at 550 nm. Further, the film obtained from a general thermoplastic resin by a melt film-forming method shows |Re[+40°]−Re[−40°]|=0 nm. Namely, when |Re[+40°]−Re[−40°]| is measured with the longitudinal direction as the direction of tilt, a phase difference of 0 nm or more can be realized.

Also, fluctuations of the Re(0), Re(+40°), and Re(−40°) values can be measured by the following method. Samples of the film are taken from 10 points in the width direction of the film and 10 points in the conveying direction of the film at even intervals. With these samples, the Re(0), Re(+40°), and Re(−40°) values are measured according to the aforementioned method and the differences between the respective maximum values and minimum values can be taken as the fluctuations.

Further, a fluctuation of the retarded phase axis can also be determined as the difference between the maximum value and minimum value when 10 points in the width direction of the film and 10 points in the conveying direction of the film are measured at even intervals.

Rth can be obtained by assuming that an index ellipsoid uniformly tilted by β° and numerically calculating the refractive indices nx, ny, nz of the index ellipsoid in each direction and substituting the values in the formula (A):

Rth=((nx+ny)/2−nz)×d Formula (A)

In the film of the present invention, ny is a refractive index in the width direction of the film. Further, nx is a refractive index in a direction where the projection component on the x axis of the film is larger than the projection component on the z axis and nz is a refractive index in a direction where the projection component on the z axis is larger than the projection component on the x axis.

The method to obtain the values of nx, ny, and nz are described in the technical data and the like of Oji Scientific Instruments Ltd. (http://www.oji-keisoku.co.jp/products/kobra/kobra.html). For example, they can be calculated from the values of Re(0°), Re(+40°), and Re(−40°), the value of the average refractive index, nₐᵥₑ, and the film thickness, d, using the following formula (B):

$$\begin{matrix}[ Expression 1 ] & \\ Re ( θ ) = [ {n}_{x} - \frac{{n}_{y} \times {n}_{z}}{\sqrt{\begin{matrix}{n}_{y} {sin ( {sin}^{- 1} ( \frac{sin ( θ )}{{n}_{ave}} ) - β )}^{2} + \\ {n}_{z} {cos ( {sin}^{- 1} ( \frac{sin ( θ )}{{n}_{ave}} ) - β )}^{2}\end{matrix}}} ] \times \frac{d}{cos ( {sin}^{- 1} ( \frac{sin ( θ )}{{n}_{ave}} ) )} & Formula ( B )\end{matrix}$$

Meanwhile, in the formula, Re(θ) represents a retardation value in a direction tilted from the normal line by an angle θ. Also, C in the formula (B) represents a tilt angle when an index ellipsoid is assumed to have uniformly tilted and is used to simply grasp the structure of an inclined phase difference film.

In the above measurement, as an assumed value of the average refractive index, the values listed in Polymer Handbook (John Wiley & Sons, Inc.) and catalogs of various optical compensation films can be used. Also, as to the films of unknown average refractive indices, the refractive indices can be measured by an Abbe refractometer. In the following, the values of average refractive indices of major optical compensation films are exemplified: cellulose acylate (1.48), cycloolefin polymer (1.52), polycarbonate (1.59), polymethyl methacrylate (1.49), and polystyrene (1.59).

Also, Re and Rth values of a film after stretching and relaxation treatment preferably satisfy the following equations, (R-1) and (R-2).

0 nm≦Re≦300 nm Equation (R-1)

10 nm≦Rth≦300 nm Equation (R-2)

More preferably, the following equations, (R-3) and (R-4), are satisfied.

20 nm≦Re≦200 nm Equation (R-3)

20 nm≦Rth≦200 nm Equation (R-4)

Re(λ) and Rth(λ) represent the in-plane retardation and the retardation in the thickness direction, respectively, at a wavelength, λ. Re(λ) is measured using KOBRA 21ADH or WR (manufactured by Oji Scientific Instruments Ltd.) by having light of a wavelength of λ nm incident in the normal line direction of the film. Measurement can be made by selecting the wavelength of measurement, λ nm, by changing the wavelength selective filters manually, programmatically, or the like.

When the film to be measured is one expressed by a uniaxial or biaxial index ellipsoid, Rth(λ) is calculated by the following method. Rth(λ) is calculated by KOBRA 21ADH or WR based on the retardation value Re(λ), an assumed value of the average refractive index, and a film thickness value entered, where the above-mentioned Re(λ) is measured at 6 points in total by making light of a wavelength of λ nm to be incident from directions tilted with respect to the direction of the normal line by 10° steps up to 50° from the normal line direction, with the in-plane retardation axis (judged by Kobra 21ADH or WR) used as the tilt axis (rotation axis) (when the retarded phase axis is not present, an arbitrary direction in the film plane is used as the rotation axis).

In the foregoing, when the film has a direction where the retardation value becomes zero at a certain tilt angle from the normal line direction with the in-plane retarded phase axis as the rotation axis, the retardation value at a tilt angle larger than the aforementioned tilt angle is calculated by KOBRA 21ADH or WR after changing the retardation value's sign to minus. In addition, based on the retardation values measured from two arbitrary tilted directions with the retarded phase axis as the tilt axis (rotation axis) (when the retarded phase axis is not present, an arbitrary direction in the film plane is used as the rotation axis), an assumed value of the average refractive index, and a film thickness value entered, Rth can also be calculated according to the following equations, (4) and (5):

$$\begin{matrix}[ Expression 2 ] & \\ Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & Equation ( 4 )\end{matrix}$$

Meanwhile, the aforementioned Re(θ) represents a retardation value in a direction tilted by an angle of θ from the normal line direction. In formula (3), nx represents the refractive index in the in-plane retarded phase axis direction, ny represents the refractive index in the direction bisecting with nx at right angles in the plane, and nz represents the refractive index in the direction bisecting with nx and ny at right angles.

Rth=((nx+ny)/2−nz)×d Equation (5)

When the film to be measured is one which cannot be expressed by a uniaxial or biaxial refractive index ellipsoid, that is, in the case of a film without an optic axis, Rth(λ) can be calculated by the following method. The above-mentioned Re(λ) is measured at 11 points by making light of a wavelength of λ nm to be incident from directions tilted from the normal line direction of the film in 10° steps from −50° to +50°, with in-plane retarded phase axis as the tilt axis (rotation axis) (judged by KOBRA 21ADH or WR). Based on the retardation values measured, an assumed value of the average refractive index, and a film thickness value entered, Rth((λ) is calculated by KOBRA 21ADH or WR.

As for the angle θ made by the film-forming direction (longitudinal direction) and the retarded phase axis of Re of the film, the closer it is to 0°, +90°, or −90°, the more preferable. That is, the deflection angle from 0°, +90°, or −90° is preferably within ±3°, more preferably within ±2°, even more preferably within ±1°. The angle θ can be any of 0° (vertical orientation), 90° or −90° (horizontal orientations), but more preferable is horizontal orientation. The in-plane and longitudinal fluctuations of Re and Rth are preferably from 0% to 8%, more preferably from 0% to 5%, even more preferably from 0% to 3%.

The change in Re and Rth before and after storing the film at 80° C. for 200 hours is preferably not less than 0% and not more than 8%, more preferably not less than 0% and not more than 6%, even more preferably not less than 0% and not more than 4%. The dimensional changes in the vertical (MD) and horizontal (TD) directions before and after storing the film at 80° C. for 200 hours is each preferably within ±0.5%, more preferably within 0.3%, even more preferably within ±0.1%.

The thickness of the film after stretching is preferably 15 μm to 200 μm, more preferably 20 μm to 120 μm, even more preferably 25 μm to 80 μm. Unevenness in thickness, in both longitudinal and width directions, is preferably within ±0.25 μm, more preferably within ±0.15 μm, even more preferably within ±0.10 μm.

### <<Material of The Film>>

The thermoplastic resin used in the present invention is not particularly limited as long as it possesses the above-mentioned optical characteristics. However, when the film is produced by using the melt extrusion method, it is preferable to use a material having good melt extrusion moldability. From that standpoint, it is preferable to select cycloolefins, cellulose acylates, polycarbonates, polyesters; polyolefins such as transparent polyethylene, transparent polypropylene, and the like; polyarylates, polysulfones, polyethersulfones, maleimide copolymers, transparent nylons, transparent fluorinated resins, transparent phenoxy resins, polyether imides, polystyrenes, acrylic copolymers, or styrene copolymers. The thermoplastic resin may comprise one kind of the aforementioned resins or mutually different two or more kinds of the aforementioned resins. Among these, cellulose acylates, cycloolefin resins obtained by addition polymerization, polycarbonates, styrene copolymers, and acrylic copolymers are preferable. The cycloolefin resins generates a large amount of foreign matter when fabricated by conventional methods and become difficult to extrude stably under conditions to decrease the foreign matter. Thus, the production method of the present invention can be effectively carried out particularly with the cycloolefin resins.

Especially, in production of a film using the production apparatus of the first embodiment, when shear deformation is applied by two rolls to cellulose acylates, a cycloolefin resin obtained by addition polymerization, and polycarbonates, all of which show positive inherent birefringence, it is possible to prepare films having |Re[+40°]−Re[−40°]|>0, with a retarded phase axis pointing in the MD direction and with the longitudinal direction as the tilt direction.

Also, when acrylic and styrene copolymers, which show negative inherent birefringence, are subjected to the aforementioned fabrication, it is possible to prepare a film having |Re[+40°]−Re[−40°]|>0, with a retarded phase axis pointing in the TD direction and with the longitudinal direction as the tilt direction.

When the present film is used for a liquid crystal display as a viewing angle compensation film, the aforementioned resin having positive or negative inherent birefringence can be appropriately selected and used by considering the characteristics of the liquid crystal display device and convenience in fabrication of a polarizing plate.

Examples of the cycloolefin copolymers usable in the present invention include a resin obtained by polymerization of norbornene-based compounds. The resins may be obtained by whichever polymerization method, ring-opening polymerization or addition polymerization.

Addition polymerization and the resins obtained thereby include those described in, for example, Japanese Patent Nos. 3517471, 3559360, 3867178, 3871721, 3907908, 3945598, National Publication of International Patent Application No. 2005-527696; Japanese Patent Application Laid-Open Nos. 2006-28993, 2006-11361; WO 2006/004376 and WO 2006/030797. Among these, one described in Japanese Patent No. 3517471 is especially preferable.

Ring-opening polymerization and the resins obtained thereby include those described in WO 98/14499; Japanese Patent Nos. 3060532, 3220478, 3273046, 3404027, 3428176, 3687231, 3873934, and 3912159. Among these, those described in WO 98/14499 and Japanese Patent No. 3060532 are especially preferable.

Among these cycloolefin polymers, those obtained by addition polymerization are preferable from a viewpoint of birefringence development and melt viscosity. For example, “TOPAS #6013” (produced by Polyplastics Co., Ltd.) can be used.

Examples of cellulose acylates usable in the present invention include any cellulose acylates where at least a part of three hydroxyl groups present in the cellulose unit is substituted with an acyl group. The acyl group (preferably an acyl group having 3 to 22 carbon atoms) can be either an aliphatic acyl group or aromatic acyl group. Above all, preferable are cellulose acylates containing aliphatic acyl groups, more preferable are those containing aliphatic acyl groups having 3 to 7 carbon atoms, even more preferable are those containing aliphatic acyl groups having 3 to 6 carbon atoms, and still more preferable are those containing aliphatic acyl groups having 3 to 5 carbon atoms. A plurality of these acyl groups may be present in one molecule of cellulose acylate. Preferable examples of acyl groups include an acetyl group, propionyl group, butyryl group, pentanoyl group, and hexanoyl group. Among these, more preferable are cellulose acylates containing one or two or more kinds selected from an acetyl group, propionyl group, and butyryl group; even more preferable is cellulose acylate (CAP) having both acetyl group and propionyl group. CAP is preferable in that the resin is easy to synthesize and its stability in extrusion molding is high.

When an optical film is produced by a melt extrusion method including the method of the present invention, the cellulose acylate to be used preferably satisfies the following equations, (S-1) and (S-2). Because the cellulose acylate which satisfies the following equations has a low melting point and improved meltability, it shows excellent film-forming property in melt extrusion.

2.0≦(X+Y)≦3.0 Equation (S-1)

0.25≦Y≦3.0. Equation (S-1)

In the equations, X represents the degree of substitution of the hydroxyl groups contained in cellulose with acetyl groups; and Y represents the total degree of substitution of the hydroxyl groups contained in cellulose with acyl groups. The “degree of substitution” referred to in the present description means the total of the proportion of the substituted hydroxyl hydrogen atom of each of the hydroxyl groups at the 2, 3, and 6 positions of cellulose. When all hydroxyl hydrogen atoms at the 2, 3, and 6 positions are substituted, the degree of substitution becomes 3.

Further, it is more preferable to use cellulose acylate which satisfies the following equations:

2.3≦(X+Y)≦2.95

1.0≦Y≦2.95.

It is even more preferable to use cellulose acylate which satisfies the following equations:

2.7≦(X+Y)≦2.95

2.0≦Y≦2.9.

There is no particular limitation on the mass average degree of polymerization and number average molecular weight of the cellulose acylates. Generally, however, the mass average degree of polymerization is about 350 to 800 and the number average molecular weight is about 70,000 to 230,000. The cellulose acylates can be synthesized by using acid anhydrides or acid chlorides as the acylating agent. In the most general industrial method of synthesis, cellulose obtained from cotton linter or wood pulp is esterified with mixed organic acid components comprising organic acids (acetic acid, propionic acid, and butyric acid) or their anhydrides (acetic anhydride, propionic anhydride, and butyric anhydride), which correspond to acetyl group or other acyl groups, to synthesize cellulose esters. For synthetic methods of the cellulose acylates which satisfy the aforementioned equations (S-1) and (S-2), reference can be made to descriptions in Journal of Technical Disclosure of Japan Institute of Invention and Innovation, No. 2001-1745, Mar. 15 (2001), pp 7-12; Japanese Patent Application Laid-Open Nos. 2006-45500, 2006-241433, 2007-138141, 2001-188128, 2006-142800, and 2007-98917.

The polycarbonates usable in the present invention include a polycarbonate resin comprising bisphenol A skeletons. This is obtained from a reaction of dihydroxy components and carbonate precursors by an interfacial polymerization method or melt polymerization method, and those described in, for example, Japanese Patent Application Laid-Open Nos. 2006-277914, 2006-106386, and 2006-284703 can preferably be used. For example, as a commercial product, “TARFLON MD1500” (produced by Idemitsu Kosan Co., Ltd.) can be used.

The styrene copolymers usable in the present invention include styrene-acrylonitrile resins, styrene-acrylic resins, multi-component (two-component, three-component, etc.) copolymers thereof, or the like. Among these, a styrene-maleic anhydride resin is preferable from a viewpoint of film strength.

In the styrene-maleic anhydride resin, the mass composition ratio of styrene and maleic anhydride is preferably styrene:maleic anhydride=95:5 to 50:50, more preferably styrene:maleic anhydride=90:10 to 70:30. Also, in order to adjust inherent birefringence, a method to hydrogenate the styrene resin can preferably be used.

As the aforementioned styrene-maleic anhydride resin, for example, “Daylark D332”, produced by Nova Chemicals Ltd., can be mentioned.

The acrylic copolymers in the present invention refer to resins obtained by polymerizing styrene with acrylic acid, methacrylic acid, and derivatives thereof, as well as the derivatives of the resins. There is no limitation on the resins as long as they do not impair the effect of the present invention. Among the resins, those containing 30% by mole or more MMA unit (monomer) based on the total monomers constituting the resin are preferable. It is more preferable that the resin contains, in addition to MMA, at least one kind of unit selected from a lactone ring unit, maleic anhydride unit, and glutaric acid anhydride unit. For example, the following resins may be used.

### (1) Acrylic Resin Containing Lactone Ring Unit

The resins described in the following documents can be used: Japanese Patent Application Laid-Open Nos. 2007-297615, 2007-63541, 2007-70607, 2007-100044, 2007-254726, 2007-254727, 2007-261265, 2007-293272, 2007-297619, 2007-316366, 2008-9378, 2008-76764, and the like. Among these, the more preferable is the resin described in Japanese Patent Application Laid-Open No. 2008-9378.

### (2) Acrylic Resin Containing Maleic Anhydride Unit

The resins described in the following documents can be used: Japanese Patent Application Laid-Open Nos. 2007-113109, 2003-292714, H6-279546, 2007-51233 (acid-modified vinylic resins described herein), 2001-270905, 2002-167694, 2000-302988, 2007-113110, and 2007-11565. More preferable among these is the resin described in Japanese Patent Application Laid-Open No. 2007-113109. Also, a commercial maleic acid-modified MAS resin (for example, Delpet 980N, produced by Asahi Kasei Chemicals Corporation) can preferably be used.

### (3) Acrylic Resin Containing Glutaric Acid Anhydride Unit

The resins described in the following documents can be used: Japanese Patent Application Laid-Open Nos. 2006-241263, 2004-70290, 2004-70296, 2004-126546, 2004-163924, 2004-291302, 2004-292812, 2005-314534. 2005-326613, 2005-331728, 2006-131898, 2006-134872, 2006-206881, 2006-241197, 2006-283013, 2007-118266, 2007-176982, 2007-178504, 2007-197703, 2008-74918, WO 2005/105918, and the like. Among these, more preferable is the resin described in Japanese Patent Application Laid-Open No. 2008-74918.

The glass transition temperatures (Tg) of these resins are preferably not lower than 106° C. and not higher than 170° C., more preferably not lower than 110° C. and not higher than 160° C., even more preferably not lower than 115° C. and not higher than 150° C. As a commercial product, “Delpet 980N” (produced by Asahi Kasei Chemicals Corporation) can be used.

The optical film of the present invention may comprise materials other than the aforementioned thermoplastic resins but it is preferable that it contains one kind or two or more kinds of the thermoplastic resins as the main component. Here, “the main component” refers to a material of the highest content among all materials contained in the composition; in an embodiment comprising two or more kinds of the aforementioned resins, the “main component” means that the total content of the resins is higher than the respective content of other materials. As materials other than the thermoplastic resin, there can be mentioned various additives, with examples including stabilizers, ultraviolet absorbers, light stabilizers, plasticizers, fine particles, and optical adjusting agents.

### (i) Stabilizer

The optical film of the present invention may contain at least one kind of stabilizer. The stabilizer is preferably added before or during heating and melting the thermoplastic resin. The stabilizer has such functions as to prevent oxidation of constituent materials of the film, to trap acids generated by decomposition, and to suppress or inhibit decomposition reactions induced by radical species generated by light or heat. The stabilizer is useful to suppress occurrence of deterioration such as coloration or lowering of molecular weight, generation of volatile components, and the like, which are caused by various decomposition reactions including unclarified decomposition reactions and the like. The stabilizer is required to function without decomposition of the stabilizer itself at a melting temperature for forming a film. Representative examples of the stabilizer include phenol-based stabilizers, phosphoric acid ester-based (phosphite-based) stabilizers, thioether-based stabilizers, amine-based stabilizers, epoxy-based stabilizers, lactone-based stabilizers, and metal deactivators (tin-based stabilizers). These are described in Japanese Patent Application Laid-Open Nos. H3-199201, H5-1907073, H5-194789, H5-271471, H6-107854, and the like. In the present invention, it is preferable to use at least either of the phenol-based stabilizer and phosphoric acid ester-based stabilizer. Among the phenol-based stabilizers, it is especially preferable to add a phenol-based stabilizer having a molecular weight of 500 or more. The preferable phenol-based stabilizers include hindered phenol-based stabilizers.

These materials can easily be obtained as commercial products and are marketed by the following makers. From Ciba Specialty Chemicals Corporation, these can be purchased as Irganox 1076, Irganox 1010, Irganox 3113, Irganox 245, Irganox 1135, Irganox 1330, Irganox 259, Irganox 565, Irganox 1035, Irganox 1098, and Irganox 1425WL. Further, from Adeka Corporation, these can be obtained as Adekastab AO-50, Adekastab AO-60, Adekastab AO-20, Adekastab AO-70, and Adekastab AO-80. Furthermore, from Sumitomo Chemical Co., Ltd. are supplied as Sumilizer BP-76, Sumilizer BP-101, and Sumilizer GA-80. Also, from Shipro Kasei Kaisha, Ltd., these can be obtained as Seenox 326M and Seenox 336B.

Furthermore, as the phosphoric acid ester-based stabilizers, the compounds described in Japanese Patent Application Laid-Open No. 2004-182979, paragraphs [0023] to [0039], may more preferably be used. Specific examples of the phosphoric acid ester-based stabilizers include the compounds described in Japanese Patent Application Laid-Open Nos. S51-70316, H10-306175, S57-78431, S54-157159, and S55-13765. Further, as other stabilizers, there may preferably be used the materials described in detail in Journal of Technical Disclosure of Japan Institute of Invention and Innovation, No. 2001-1745, Mar. 15 (2001), pp 17-22.

In order for the phosphoric acid ester-based stabilizers to keep stability at high temperature, it is useful that they are of high molecular weight. The molecular weight thereof is preferably 500 or higher, more preferably 550 or higher, especially preferably 600 or higher. Furthermore, it is preferable that at least one substituent is an aromatic ester group. In addition, the phosphoric acid ester-based stabilizers are preferably triesters and are desirably free of contamination with impurities such as phosphoric acid, monoesters, and diesters. When these impurities are present, the content thereof is preferably 5% by mass or less, more preferably 3% by mass or less, especially preferably 2% by mass or less. These include the compounds described in Japanese Patent Application Laid-Open No. 2004-182979, paragraph [0023] to [0039], and further those described in Japanese Patent Application Laid-Open Nos. S51-70316, H10-306175, S57-78431, S54-157159, and S55-13765. Preferable specific examples of the phosphoric acid ester-based stabilizers include the compounds mentioned below but the phosphoric acid ester-based stabilizers usable in the present invention are not limited to these.

These are commercially available and can be obtained from Adeka Corporation as Adekastab 1178, Adekastab 2112, Adekastab PEP-8, Adekastab PEP-24G, Adekastab PEP-36G, and Adekastab HP-10; also from Clariant Ltd. as Sandostab P-EPQ. Further, stabilizers containing phenol and phosphoric acid ester units within the same molecule can also preferably be used. These compounds are described in further detail in Japanese Patent Application Laid-Open No. H10-273494. Examples of such compounds are included in the aforementioned examples of stabilizers but are not limited to these. Representative commercial products include Sumilizer GP available from Sumitomo Chemical Co., Ltd. These are marketed as Sumilizer TPL, Sumilizer TPM, Sumilizer TPS, and Sumilizer TDP. Also available is Adekastab AO-412S from Adeka Corporation.

The stabilizers can be used each independently or in a combination of two or more kinds. The amount to be added is chosen appropriately in a range which does not hurt the object of the present invention. The amount of the stabilizer to be added is, based on the mass of the thermoplastic resin, preferably 0.001 to 5% by mass, more preferably 0.005 to 3% by mass, even more preferably 0.01 to 0.8% by mass.

### (ii) Ultraviolet Absorber

The optical film of the present invention may contain one kind or two or more kinds of ultraviolet absorbers. Preferable as the ultraviolet absorber is one which has, from a standpoint of deterioration prevention, an ability to absorb ultraviolet light of wavelength 380 nm or less and which has, from a viewpoint of transparency, little absorption of visible light of a wavelength 400 nm or longer. For example, there may be cited oxybenzophenone compounds, benzotriazole compounds, salicylic acid ester compounds, benzophenone compounds, cyanoacrylate compounds, and nickel complex salt compounds. Especially preferable ultraviolet absorbers are the benzotriazole compounds and benzophenone compounds. Among these, the benzotriazole compounds are preferable because they cause less unnecessary coloration in mixed esters of cellulose. These are described in Japanese Patent Application Laid-Open Nos. S60-235852, H3-199201, H5-1907073, H5-194789, H5-271471, H6-107854, H6-118233, H6-148430, H7-11055, H7-11056, H8-29619, H8-239509, and 2000-204173.

The amount of the ultraviolet absorber to be added is, based on the mass of the thermoplastic resin, preferably 0.01 to 2% by mass, more preferably 0.01 to 1.5% by mass.

(iii) Light Stabilizers

The optical film of the present invention may contain one kind or two or more kinds of light stabilizers. The light stabilizers include hindered amine light stabilizers (HALS) and, more specifically, 2,2,6,6-tetraalkylpiperidine compounds, acid addition salts thereof, or complexes thereof with metal compounds, as is described in columns 5 to 11 of U.S. Pat. No. 4,619,956 and columns 3 to 5 of U.S. Pat. No. 4,839,405. These are commercially available from Adeka Corporation as Adekastab LA-57, Adekastab LA-52, Adekastab LA-67, Adekastab LA-62, and Adekastab LA 77; and from Ciba Specialty Chemicals Corporation as TINUVIN 765 and TINUVIN 144.

These hindered amine-based light stabilizers may be used each independently or in a combination of two or more kinds. Further, these hindered amine-based stabilizers may, of course, be used together with plasticizers, stabilizers, ultraviolet absorbers, and the like, or may be incorporated as a part of the molecule of these additives. The amount of the light stabilizer to be added is determined in a range where the effect of the present invention is not damaged. Generally, based on 100 parts by mass of the thermoplastic resin, the amount to be added is about 0.01 to 20 parts by mass, preferably about 0.02 to 15 parts by mass, especially preferably about 0.05 to 10 parts by mass. The light stabilizer may be added in any stage of preparation of a melt of a thermoplastic resin composition; for example, it may be added at the end of a melt preparation process.

### (iv) Plasticizer

The optical film of the present invention may contain a plasticizer. Addition of a plasticizer is preferable from a viewpoint of modifying film properties such as improving mechanical strength, imparting flexibility, imparting an anti-water absorbing property, lowering moisture permeability, and the like. Also, when the optical film of the present invention is produced by a melt film-forming method, the plasticizer may be added for the purpose of lowering the melting temperature of the film constituting material than the glass transition temperature of the thermoplastic resin used or for the purpose of lowering the viscosity at the same heating temperature than the thermoplastic resin not containing the plasticizer. In the optical film of the present invention, a plasticizer selected, for example, from phosphoric acid ester derivatives or carboxylic acid ester derivatives is preferably used. Also, a polymer obtained by polymerizing ethylenic unsaturated monomers, acrylic polymer, acrylic polymer having an aromatic ring on the side chain, acrylic polymer having a cyclohexyl group on the side chain or the like, all having a weight average molecular weight of 500 to 10,000, as described in Japanese Patent Application Laid-Open No. 2003-12859, can also be used preferably.

### (v) Fine Particle

The optical film of the present invention may contain fine particles. The fine particles include those of inorganic compounds as well as those of organic compounds, either of which may be used. The average primary particle size of the fine particles contained in the thermoplastic resin in the present invention is, from a viewpoint of keeping the haze low, preferably 5 nm to 3 μm, more preferably 5 nm to 2.5 μm, even more preferably 10 nm to 2.0 μm. Herein, the average primary particle size of the fine particles is determined by observing the thermoplastic resin by a transmission electron microscope (magnification ratio: 500,000 to 1,000,000 times) and obtaining the average of the primary particle sizes of 100 particles. The amount of the fine particles to be added is, based on the thermoplastic resin, 0.005 to 1.0% by mass, more preferably 0.01 to 0.8% by mass, even more preferably 0.02 to 0.4% by mass.

### (vi) Optical Adjusting Agent

The optical film of the present invention may contain optical adjusting agents. The optical adjusting agents include a retardation adjusting agent and, for example, those described in Japanese Patent Application Laid-Open Nos. 2001-166144, 2003-344655, 2003-344655, and 2003-66230 may be used. By addition of an optical adjusting agent, the in-plane retardation (Re) and retardation in the thickness direction (Rth) can be controlled. The amount to be added is preferably 0 to 10% by mass, more preferably 0 to 8% by mass, even more preferably 0 to 6% by mass.

(vii) Lubricant

The optical film of the present invention may contain lubricants. By addition of a lubricant, friction between the resin and the wall of the extruder is decreased, and foreign matter and gel generated inside the extruder can be suppressed. The lubricants include phenolic radical trapping agents such as Irganox 1010 and the like which melt into oil at the inlet of the extruder, amide-based lubricants such as EBSA, higher alcohol ester-based lubricants, and hydrocarbon-based lubricants such as waxes. Also, inorganic fillers such as silica particles can be used. According to the film production method of the present invention, even when addition of the lubricant caused lowering of the friction between the resin and the wall of the extruder, and the feed force decreased in the first half of the feed zone, appropriate friction can be maintained by lowering the temperature of the second half of the feed zone. Therefore, the present invention is particularly effective when a lubricant is added because, according to the present invention, the feed force can be secured and the resin can be extruded stably.

### EXAMPLES

In the following, the features of the present invention will be described in more detail by Examples and Comparative Examples. The material, amount used, proportion, content of treatment, treating procedure, and the like, shown in the following Examples, may be changed appropriately, so long as such changes do not deviate from the purpose of the present invention. Therefore, the scope of the present invention should not be deemed limited by the Examples shown below.

### Examples

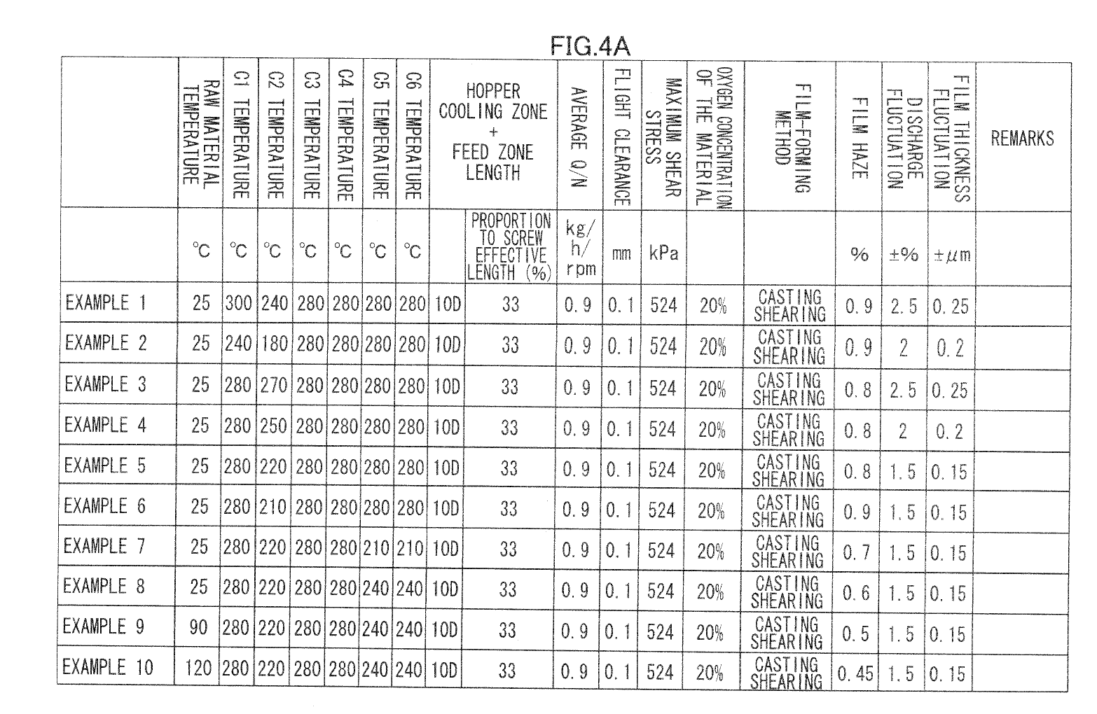

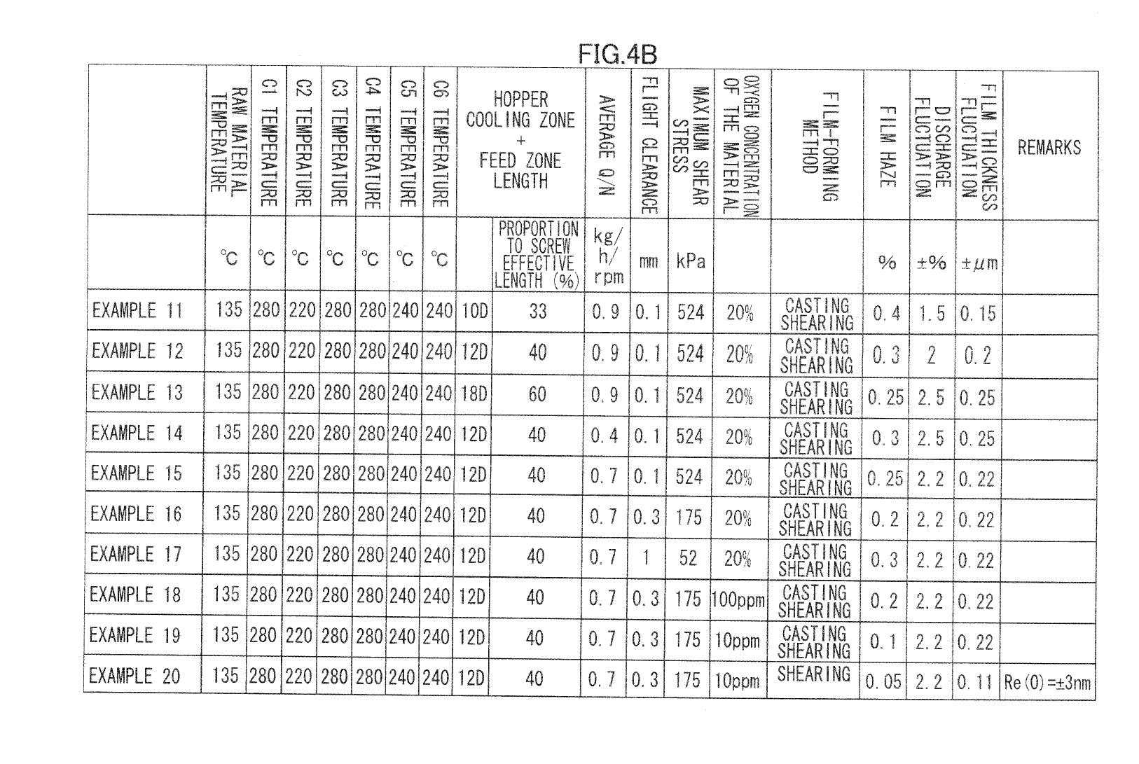

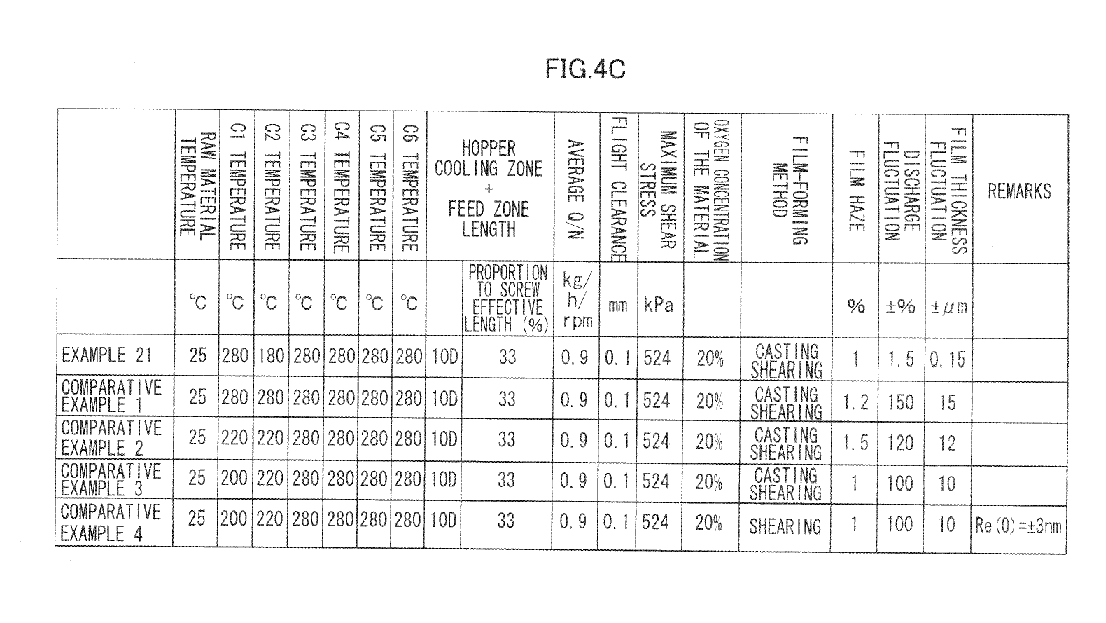

As for the materials of a film, TOPAS #6013 (a cycloolefin copolymer, Tg=140° C.) as the resin and 0.1% by weight of Irganox 1010 (a radical trapping agent) as the additive were used to prepare a film. The extruder was equipped with a full flight uniaxial screw of Φ50 mm and with L/D=30. The temperature conditions inside the extruder are shown in FIGS. 4A to 4C. In addition, the position of each temperature in FIGS. 4A to 4C shows the following section; C1: first half of the feed zone, C2: the second half of the feed zone, C3: first half of the compression zone, C4: second half of the compression zone, C5: first half of the metering zone, and C6: second half of the metering zone. Also, denotation of signs are; Q: discharge amount, N: rotation frequency of the screw, D: screw diameter, and (Q/N): discharge amount per one rotation of the screw. In the present Examples, the film production was carried out with rotation speed of the screw at 25 rpm and (Q/N)_{MAX} of 1 kg/h/rpm. In addition, shear stress can be obtained by the following equations.

γ=π·D·N/60 h Equation (A)

σ=γ×η=(π·D·N/60 h)×η Equation (B)

(σ: shear stress [Pa], γ: shear speed [s⁻¹], η: viscosity [Pas], D: screw diameter [mm], N: rotation speed of the screw [rpm], h: flight clearance [mm])

Production of the film was carried out in the order of a raw material drier equipped with a temperature regulator, an extruder, a gear pump, a die, and film-forming by rolls. Film-forming was conducted by two methods, a casting method where the peripheral speed of the two rolls is the same and a shearing method where the peripheral speed of the two rolls is different. Also, the production was carried out so that the average thickness after cooling of the film produced became 100 μm. In addition, the hopper cooling zone is cooled by following conditions.

Heat carrier which is circulated in the hopper cooling zone: water

Temperature of the water at inlet port: 25° C.

Length of the hopper cooling zone: 50% length of the feed zone A

The results are shown in FIGS. 4A to 4C.

Meanwhile, haze of the film was measured as follows. The film produced was dissolved in cyclohexane at room temperature to obtain a 10 wt % solution. The haze of this solution was measured by a haze meter (NDH 2000, produced by Nippon Denshoku Industries Co., Ltd.). The larger haze value means occurrence of more gel in the polymer. Further, a fluctuation in the discharge amount was evaluated with the temporal change of a pressure at the extruder outlet as an indicator.

In addition, the film preferably has the following numerical ranges as a product.

Film thickness fluctuation: within ±1.0 μm,

Discharge fluctuation: within ±2.5%,

Haze: 1.0% or less.

As shown in FIGS. 4A to 4C, in the Examples 1 to 21 where the temperature (C1) of the first half of the feed zone was set higher than that (C2) of the second half of the feed zone and where the temperatures of the compression zone (C3, C4) and metering zone (C5, C6) were set higher than that (C2) of the second half of the feed zone, there could be produced excellent films where film haze was suppressed. Further, excellent films with suppressed film haze could be produced by combining the conditions in extrusion, as can be seen in Examples 7 to 20 where the temperature of the metering zone (C5, C6) were set lower than the temperatures of the compression zone (C3, C4), in Examples 9 to 20 where the temperature at the inlet of the extruder was higher than (Tg−50) and lower than Tg, in Examples 14 to 20 where the discharge amount (Q/N) was 30 to 80% of the theoretical maximum discharge amount (Q/N)_{MAX}, in Examples 16 to 20 where the maximum shear stress was in a range of 10<σ<500, in Examples 18 to 20 where the oxygen concentration in the extruder was 100 ppm or less, and in Example 20 where the film forming was carried out by a shearing method. Also, in Example 21 where the difference in the temperature C1 of the first half of the feed zone and temperature C2 of the second half of the feed zone was 100° C., the haze value of the film was higher compared to other Examples but it was to a degree that presented no problem in quality. Furthermore, in the films of Examples 1 to 21, the fluctuations in thickness were less than ±0.25 μm and, thus, excellent films could be manufactured.

What is claimed is:

1. A method for producing a film, comprising the steps of:
melting a thermoplastic resin in an extruder having a feed zone, a compression zone, and a metering zone;
discharging a melted resin from the extruder and supplying the melted resin to a die;
extruding the melted resin through the die in a sheet-like form; and
cooling and solidifying the sheet-like melted resin to produce a film;
wherein a relationship between a temperature, T₁ [° C.], of the melted resin in a first half of the feed zone and a temperature, T₂ [° C.], of the melted resin in a second half of the feed zone satisfies a following equation (1):
Tg+30≦T₂<T₁≦Tg+160 (1)
where a glass transition temperature of the resin is denoted by Tg.

2. The method for producing a film according to claim 1, wherein an additive to impart a slipping effect is added to the melted resin.

3. The method for producing a film according to claim 1, wherein the relationship between the temperature, T₁ [° C.], of the melted resin in a first half of the feed zone and the temperature, T₂ [° C.], of the melted resin in a second half of the feed zone satisfies the following equation (2):
80>T₁−T₂>0 (2).

4. The method for producing a film according to claim 1, wherein a relationship between temperature of the compression zone and temperature of the metering zone satisfies the following equation (3):
metering zone temperature<compression zone temperature (3).

5. The method for producing a film according to claim 1, wherein a total length of a hopper cooling zone of the extruder and the feed zone is 30% to 60% of an effective length of a screw.

6. The method for producing a film according to claim 1, wherein temperature, T, of a raw material resin at an inlet is in a range of (Tg−50)<T<Tg.

7. The method for producing a film according to claim 1, wherein a discharge amount (Q/N) of the extruder is 30 to 80% of a theoretical maximum discharge amount (Q/N)_{MAX}.

8. The method for producing a film according to claim 1, wherein a maximum shear stress, σ, generated inside the extruder, is 10<σ<500.

9. The method for producing a film according to claim 1, wherein an oxygen concentration inside the extruder is 100 ppm or less.

10. The method for producing a film according to claim 1, wherein the thermoplastic resin is a cycloolefin resin.

11. The method for producing a film according to claim 1, wherein the discharged melted resin is nipped between two rolls having different peripheral speeds, and cooled and solidified to produce a film.

12. An optical film obtained by a film production method according to claim 1, wherein unevenness in film thickness in longitudinal and width directions is within ±0.25 μm.
